(19) United States
(12) Patent Application Publication
(10) Pub. No.: US 2018/0238284 A1
(43) Pub. Date: Aug. 23, 2018

(54) HIGH-PRESSURE LIQUID FILTER WITH SUPPORT STEM AND APPLICATION OF THIS FILTER IN FUEL SYSTEM

(71) Applicant: UAB "AUKSTO SLEGIO FILTRAVIMO SPRENDIMAI", Velybniskiu k., Vilniaus r. sav. (LT)

(72) Inventor: Dmitrij KRUM, Vilnius (LT)

(73) Assignee: UAB "AUKSTO SLEGIO FILTRAVIMO SPRENDIMAI", Velybniskiu k., Vilniaus r. sav. (LT)

(21) Appl. No.: 15/757,336

(22) PCT Filed: Aug. 31, 2016
(86) PCT No.: PCT/IB2016/055199

§ 371 Date: Mar. 2, 2018

(30) Foreign Application Priority Data
Sep. 4, 2015 (LT) LT2015-077

(51) Int. Cl. F02M 61/16; B01D 35/06; B01D 35/26; B01D 35/00; B01D 29/19; B01D 39/12; B01D 35/30

(52) U.S. Cl. CPC F02M 61/165; B01D 35/06; B01D 35/26; B01D 35/005; B01D 2201/0415; B01D 39/12; B01D 35/30; F02M 2200/20; F02M 2200/27; B01D 29/19

(57) ABSTRACT

This description presents liquid filter comprising filter housing containing all parts of the filter; filtering element trapping impurities present in liquid being filtered; solid support element preventing filtering element from getting deformed, filter housing cover, and other components.

The most important element presented in this description is filter support stem enabling the use of filter with extreme pressure levels of the filtered liquid (up to 300 MPa) and sudden changes to these levels. The support stem prevents filtering element from getting deformed to the extent that would render it unfunctional.

One of the possible applications of the filter presented herein is filtering high-pressure diesel fuel between high-pressure pump and injectors.

An important feature of this liquid filter is that it is not integrated into other standard parts of fuel system, but added to fuel system as separate component that can be easily replaced without replacing other parts of the system.

To improve durability and ensure reusability of filtering element of liquid filter this element is made of metal or other material possessing similar properties.

### FIELD OF THE INVENTION

The presented invention relates to liquid filters, more specifically to filters capable of functioning in extreme pressure zones, such as filters installed between internal combustion engine fuel system high-pressure pump and injectors.

### DESCRIPTION OF RELATED ART

Pressure of fuel delivered to internal combustion chamber by injectors used in modern diesel internal combustion engines may be up to 300 MPa and this pressure is subject to sudden changes. With such pressure levels and sudden changes any impurities in fuel are extremely harmful to injectors and other parts. Therefore, a filter capable of removing impurities in high-pressure fuel is required. The said filter can also be used for other applications where extreme liquid pressure is involved.

The document U.S. Pat. No. 6,446,885B1 (published on 10 Sep. 2002) presents fuel system with filtering element used in high-pressure zone but permanently integrated in fuel injector. Therefore, if filtering element gets clogged the entire device must be replaced, regardless of perfect functioning of injecting element.

The document U.S. Pat. No. 5,639,369A (published on 17 Jun. 1997) presents filter support element with reinforcing ribs and apertures for filtered material to be removed from filter. Such design enables high flowrate of liquid, but because of the said apertures the hollow element will not be rigid enough and fail to withstand extreme pressures in the filtered material.

The U.S. Pat. No. 6,293,410B1 (published on 25 Sep. 2001) describes filter with similarly shaped support stem, but that filter (and support stem, too) cannot operate under high pressure. Furthermore, the description reveals that the support stem has a cap and is hollow. Hollow stem will not function under extreme pressures: it will get damaged. Moreover, filtering material according to the invention cited is mineral; it would be unsuitable for use under extreme pressures of liquid as it would get damaged. Last but not least, the filter according to the invention cited is not reusable.

The documents presenting related art reveal the following major shortcomings:
The documents found present no solution to ensure that filtering element (such as internal support element) would resist compression and retain its shape under very high pressures (up to 300 MPa) of filtered liquid.
The documents found usually present filtering element materials that are not capable of withstanding very high pressures. These materials erode, crack, wear or otherwise lose their strength over time under the action of high pressure.
The documents found describe filtering element as integral part of fuel system. Replacement of clogged parts of filtering element requires replacement of the entire part where filtering element is installed.
The documents found usually present filtering element that is not reusable both because of short lifetime of filtering element material under high pressure and because of filter design not allowing for removal of filtering element.

The following description presents filter design without the aforementioned shortcomings.

### SUMMARY OF THE INVENTION

This description presents liquid filter comprising filter housing containing all parts of the filter; filtering element trapping impurities present in the filtered liquid; solid support element preventing major deformations of filtering element that would render it unfunctional, filter housing cover, and other components.

The most important element presented in the current description is filter support stem enabling use of filter under extreme pressures of filtered liquid (up to 300 MPa). The support stem is designed so as to prevent filtering element from getting crushed, collapsed or otherwise deformed that would render it unfunctional.

One of the possible applications of the filter presented herein is filtering high-pressure diesel fuel between high-pressure pump and injectors.

An important feature of this filter is that it is not integrated into other, standard parts of fuel system, but added to fuel system (or, after some modifications, to high-pressure fuel line) as separate component that can be easily replaced without affecting the functioning of other parts in the system.

Filtering element in the filter is made of metal, which makes it resistant to high pressures, moreover it is reusable.

### BRIEF DESCRIPTION OF THE DRAWINGS

FIG. 1 shows support element. On the left: view perpendicular to longitudinal axis; on the right: side view.

FIG. 2 shows filter housing. Side view.

FIG. 3 shows housing cover. Side view.

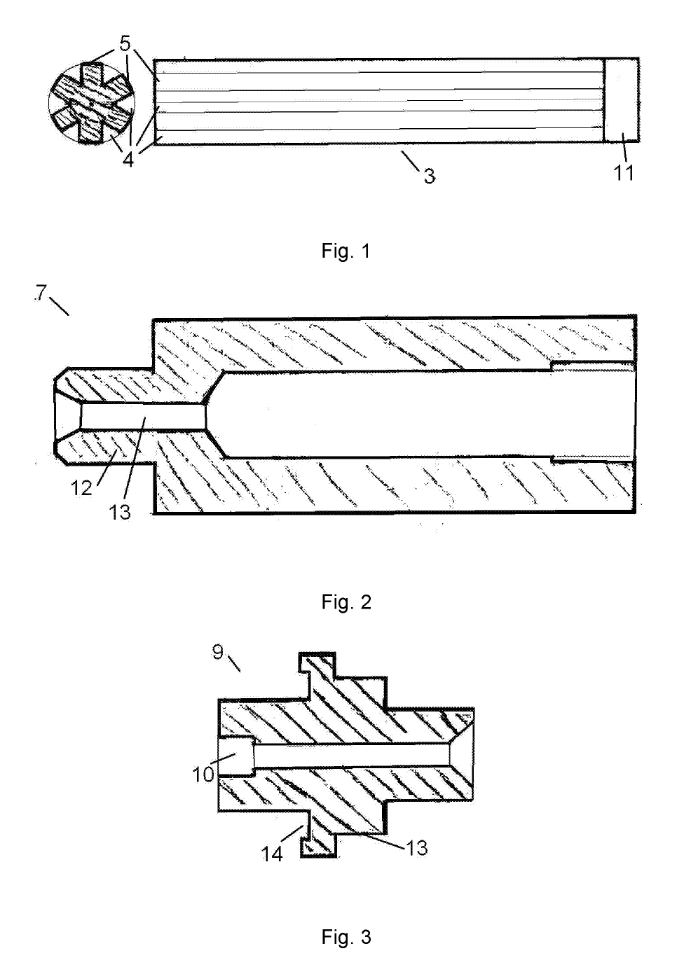

Scaling proportions in the figures may vary.

### DESCRIPTION OF THE PREFERRED EMBODIMENTS

The key terms used in this description are:

Filtering element refers to functional element that the filtered substance penetrates.

Filter refers to a whole part, element that receives unfiltered substance, filters it and releases. Filter presented in this description comprises housing, housing cover, filtering element, support stem, and other components.

Vehicles with internal combustion engines using diesel as fuel usually have at least two fuel pumps. One fuel pump is for delivering fuel from fuel tank to high-pressure fuel pump; this part of fuel system is where fuel filter is installed. By direction of fuel flow within fuel system it is the first element for filtering fuel. It is intended for removal of 3-5 μm and larger impurities from fuel. Downstream of this filter, fuel enters high-pressure pump that gives fuel pressure necessary for it to be injected into combustion chamber of internal combustion engine by fuel injectors. In modern diesel engines these pressures can reach up to 3000 bar (300 MPa). Downstream of this high-pressure fuel pump there usually is an element distributing fuel to injectors and the said injectors. Furthermore, downstream of this high-pressure pump, fuel is sometimes filtered in the injectors or right before entering them, however such filtering elements are usually integrated in the nozzles or other elements, which necessitates the replacement of the whole part in case these elements get clogged. In case of nozzle, such replacement is extremely costly.

The presented filter can also be used with petrol internal combustion engines.

Filter downstream of high-pressure fuel pump is necessary because of slivers of high-pressure fuel pump which get into fuel; risk of poor quality filter installed upstream of high-pressure fuel pump, or inappropriate replacement of such filter. All such impurities are particularly detrimental and dramatically reduce lifetime and service life and performance of fuel injectors and other elements of fuel system.

The invention presents fuel filter installed in fuel system downstream of high-pressure fuel pump (for example, in high-pressure fuel line) and not integrated into any currently available, standard element of fuel system. Filter installed in this part of fuel system must possess very high resistance to high pressures of fuel and their sudden changes. For this reason, support stem ensuring support to and compression-resistance of filtering element in fuel filter has been created for this filter.

High-pressure fuel filter comprises at least the following parts: filtering element, support stem, filter housing, housing cover, magnet and other.

The main element in any filter is filtering element that usually contains porous material that, as the filtered material penetrates it, catches and separates impurities in the filtered material. For high-pressure fuel filter the filtering element made of metal or other similarly strong material is used. The present invention utilizes filtering element based on sintered metal mesh tube technology. The element comprises metal mesh layers packed by method of diffusion and having apertures of 5-10 μm. At least two such layers are intended for reinforcement of physical structure of filtering element and one for protection. Liquid permeability coefficient of such filtering element ranges from 0.38 to 0.5. Filtering element in accordance with this invention is shaped as hollow cylinder without both bases; in other words, it is shaped as round tube open at both ends. The main requirement for size of filtering element is that it must fit on support stem and inside filter housing. The present invention utilizes filtering element that has length of ˜43 mm, internal diameter of ˜8 mm, and external diameter of ˜10 mm. With different embodiments size, shape, and other characteristics of filtering element may vary.

In case of the present invention, the filter design is such that once inside filter fuel gets on the outside of filtering element and under action of pressure penetrates through filtering element inside of filtering element from the outside of filtering element. This way fuel pressure exerts compression on filtering element. To ensure structural rigidity of filtering element, support stem (3) is placed inside filtering element. In case of the present invention, support stem (3) is made of calibrated steel 45 or calibrated steel 40h or other material possessing identical or equivalent physical and chemical properties. Support stem (3) shape resembles cylinder. In case of the present invention, external dimensions of the said support stem (3) are the following: cylinder base diameter is ˜8 mm and cylinder length is ˜48 mm, however dimensions may vary across applications. They may be different if, for example, truck or tractor engine requires larger fuel throughput.

Grooves (4) are made on external walls (except cylinder bases) of support stem (3) along cylinder (in parallel with cylinder axis) by milling or other method. With other embodiment, the said grooves (4) can be made simultaneously, at the time of shaping the entire support stem (3). Having penetrated filtering element, fuel enters the said grooves (4) that direct filtered fuel towards filter opening made for fuel to exit. In case of the present invention the said grooves (4) are triangular-shaped at cross-section, with one angle of the triangle pointing to central axis of cylinder and other two angles to the outside of cylinder. Thus two sides of the said triangular-shaped groove (4) match sides of support stem (3) protrusions (5) that support filtering element and the third side of the said triangle does not actually exist, it is imaginary and presented in this description solely for the purposes of more accurate describing of groove (4) shape at cross-section. Having penetrated filtering element, fuel enters the groove (4) at its imaginary side. The said groove (4) that is triangular-shaped at cross-section is made all along support stem (3). In case of the present invention, 6 grooves (3) are made, they are arranged at equal distances along the entire circle of cross-section of the support stem (3), i.e. the distance from the centre of one groove (4) to the centre of next groove (4) is support stem (3) cross-section circle arc limited by radiuses of the said circle, which make a 60° angle. Length of support stem (3) cross-section circle arc limited by groove (4) sides is ˜2 mm. Depth of each groove (4) (distance from support stem (3) cross-section circle to the deepest point in the groove (4)) is ˜2 mm. Grooves (4) are made all along the support stem (3), from one end of support stem (3) to another, i.e. stem (3) cross-section is the same all along. In another embodiment, groove (4) starting at one end of support stem (3) does not extend to the other end, instead it ends a few millimetres (3-5 mm) before the other end of support stem (3). Support stem (3) not only ensures rigidity and resistance to compression, but also serves to direct fuel within filter. In combination with other structural elements of filter support stem (3) must ensure that all fuel that enters filter housing goes through filtering material. Thus tight contact of support stem (3) with filtering material must be ensured at both ends of support stem (3). In another embodiment tight contact of filtering element must be ensured at one end of support stem (3), which faces liquid inlet, while at the other end of stem (3) it must be in tight contact with the inside of filter housing (7).

As fuel flow grooves (4) in support stem (3) are made, protrusions (5) of support stem (3) are obtained between the said grooves (4). Shape of protrusions (5) remains such that protrusions (5) with grooves (4) give a cylinder shape to the support stem (3). Once filtering element is mounted on the support stem (3), filtering material rests on these protrusions (5) that are intended for preserving shape of filtering material under the action of high pressure of fuel and sudden pressure changes. Cross-section circle length of the external part of protrusion (5) that filtering material rests on is ˜2 mm. Therefore, filtering material rests on support element (3) by approximately a half of its internal area, the other half being intended for fuel to go into grooves (4). Support stem (3) and filtering material can be attached to each other at their ends by soldering, welding, or by some other method of tight attachment.

One end of support stem (3) is impressed into or otherwise embedded in a recess, aperture (10) made in the housing cover (9). In case of embodiment where grooves (4) are made all along the support stem (3) (but not limited to this embodiment), magnet (11) or other material capable of attracting other materials is attached to the other end of support stem (3). For the purposes of the present invention the magnet (11) attached features capability to attract ferromagnetic materials. Shape of this magnet (11) resembles cylinder with the diameter equal or slightly larger than the diameter of cross-section of support stem (3). In addition to its primary function magnet (11) also serves to cover apertures made in cylinder-shaped bases of support stem in the course of shaping the grooves (4) all along the support stem (3). Magnet (11) must be attached so as to ensure good seal between the support stem (3) and the magnet (11) and filtering material so that fuel that enters filter housing (7) would have no other way to exit filter than by going through filtering element.

Filter housing (7) is intended to house filtering element with support stem (3), at one end it receives fuel to be filtered and at the other end it releases filtered fuel through housing cover (9). In the present invention filter housing (7) shape resembles cylinder. One end of said cylinder has cylinder-shaped element (12) attached (or made integral part of housing) serving to make tight attachment of filter housing (7) to fuel system elements. The outside of the said element (12) features thread or other structural element to enable tight attachment of filter housing (7) to other elements in the fuel system, moreover the said element (12) has aperture (13), through which fuel enters filter housing (7).

In case of the present invention, filter housing (7) must be capable of withstanding aforementioned levels and sudden changes of liquid pressure. For this reason, housing (7) is made of steel or other material possessing similar physical and chemical properties and the minimum thickness of housing (7) walls is 6 mm. External dimensions of housing (7) are as follows: length (with additional element (12) to which other elements of fuel system are attached, but without housing cover (9)) is ˜87 mm, diameter at cross-section perpendicular to longitudinal axis is ˜26 mm.

As mentioned before, one end of housing (7) has element (12) making tight attachment (connection) of filter housing (7) to fuel system and the other end of the housing (7) has thread or other structural feature to enable tight attachment of the housing cover (9) to the housing (7). In case of the present invention, the said thread is on the inside of housing (7), it is recessed in housing (7) ˜13 mm (in parallel to longitudinal axis), i.e. housing cover (9) is screwed into housing (7) by ˜13 mm. Alternatively, housing and housing cover can be connected by some other method not presented in this description.

Housing cover (9) is made of steel or other material possessing comparable physical and chemical properties. Housing cover (9) is screwed into (or otherwise attached to) filter housing (7) and support stem (3) is impressed into (or otherwise fixed in) aperture (10) located at one end of the housing cover (9) and facing inside of filter. This aperture (10) has diameter of ˜8 mm and depth of ˜5 mm; further diameter of this aperture (10) suddenly decreases to 6 mm and runs along (in parallel to longitudinal axis of the housing cover (9)) the entire housing cover (9). As mentioned before, support stem (3) is inserted in the aperture (10) and props with its end against decrease in diameter of aperture (10), however through grooves (4) in support stem (3) fuel can enter housing cover aperture (10) extending all along housing cover. The said change in aperture (10) diameter from 8 mm to 6 mm affects fuel flow through the filter, therefore for other embodiments these sizes may differ. Housing cover (9) end facing the outside of the filter housing (7) is externally threaded or contains some other structural element on its outside, which allows it to be attached to other parts of fuel system. Between the two ends of housing cover (9), one of which is screwed into filter housing (7) and the other serves for attachment of other parts of fuel system, there is housing cover (9) portion (13) with diameter larger than the said ends of the filter. This larger-diameter portion (13) can be hexagon-shaped so that standard wrench can be used on it. Larger-diameter portion (13) plane facing filter side has a dent (14) for placing copper washer to ensure tight seal between filter housing (7) and filter cover (9). Copper washer thickness must exceed depth of the dent (14) in the plane facing filter. Embodiment with washer but without a dent (14) is possible.

Support stem (3) with filtering element on it is fastened to the filter housing cover (9); the cover (9) is hermetically attached to the filter housing (7) and the entire filter is installed in the fuel system.

High-pressure liquid filter in accordance with this invention is reusable. Should filtering material get clogged with impurities from liquid, the filter can be easily disassembled to clean filtering material.

High-pressure liquid filter in accordance with this invention ensures adequate fuel flow and pressure decrease (with filter not clogged) is too small to be detected by vehicle on-board computer. When filter gets clogged, however, vehicle on-board computer may record pressure decrease, which can serve as indication that the filter is clogged, needs cleaning or replacement.

The present description introduces the design of liquid filter. Filter application for supplying high-pressure diesel into internal combustion engine is just one of the potential embodiments. The design described does not restrict filter application in other areas.

Concepts of “downstream of” and “upstream of” are used in the present description when describing location of fuel system components within the system; they denote location of the described component in relation to reference component (the one compared to). The concept of “downstream of” means location of the described component when fuel normally flowing from tank to engine reaches the reference component first and only then reaches the described component; the term “upstream of” means that fuel reaches the described component first and only then comes to reference component.

To illustrate and describe this invention, description of preferred embodiments is given above. This is not a complete or limiting description aimed at prescribing a precise embodiment or implementation option. The description given above should be regarded more as an illustration than a constraint. Obviously, the specialists in this field may clearly see a multitude of modifications and variations. The embodiment has been selected and described so as to enable the specialists in this field to best understand the principles behind this invention and their best practical application for different embodiments with different modifications fit for a specific application or embodiment customisation. The invention scope is defined by the attached claims and their equivalents wherein all the terms used have the broadest possible meanings unless stated otherwise.

Embodiments described by specialists in the respective field may contain changes that do not depart from the scope of this invention, as described in the claims given below.

1. A liquid filter with:
a filtering element that a filtered liquid passes through where the filtering element catches impurities present in the liquid;
a filter housing in which other elements of filter are placed and to which a filter housing cover, through the filtered liquid comes out, is tightly attached;
a support stem serving to preserve the shape of the filtering element;
wherein the support stem is a solid homogeneous element designed for use in high and suddenly changing pressure environments and has grooves that the filtered liquid enters and protrusions that protect the filtering element material against compression, running along the support stem, where the support stem is made of calibrated steel 45 or calibrated steel 40h or other material possessing identical or comparable physical and chemical properties.

2. The liquid filter according to claim 1, which incorporates a magnet placed inside the filter housing which is intended for attracting ferromagnetic materials.

3. The liquid filter according to claim 1, wherein the filtering element is mounted on the support stem and these elements are attached to each other at their ends by soldering, welding, or by some other method of tight attachment.

4. The liquid filter according to claim 1, wherein the magnet is tightly attached to one end of the support stem.

5. A fuel system comprising the liquid filter according to claim 1, wherein the filter in a supply part of the fuel system is placed between high-pressure fuel pump and injectors.

6. The fuel system according to claim 5, wherein the liquid filter is added to the fuel system as a separate element not integrated into any part.

7. A vehicle with an internal combustion engine, which incorporates the liquid filter according to claim 1.

8. The liquid filter according to claim 1, wherein the filtering element is mounted on the support stem and these elements are attached to each other at their ends by soldering, welding, or by some other method of tight attachment.

9. The liquid filter according to claim 2, wherein the magnet is tightly attached to one end of the support stem.

10. The liquid filter according to claim 3, wherein the magnet is tightly attached to one end of the support stem.

11. A fuel system comprising the liquid filter according to claim 2, wherein the filter in a supply part of the fuel system is placed between high-pressure fuel pump and injectors.

12. A fuel system comprising the liquid filter according to claim 3, wherein the filter in a supply part of the fuel system is placed between high-pressure fuel pump and injectors.

13. A vehicle with an internal combustion engine, which incorporates the liquid filter according to claim 2.

14. A vehicle with an internal combustion engine, which incorporates the liquid filter according to claim 3.
